(19) United States
(12) Patent Application Publication
(10) Pub. No.: US 2022/0187857 A1
(43) Pub. Date: Jun. 16, 2022

(54) CONTROL SYSTEM FOR REGULATING WATERWORKS PRESSURE

(71) Applicant: Griswold Industries, Costa Mesa, CA (US)

(72) Inventors: Mario Ducommun, Belmont-sur-Lausanne (CH); Hugo van Buel, La Conversion (CH); Arnaud Bonjour, Blonay (CH); Cedric Lacroute, Touillon et Loutelet (FR)

(73) Assignee: Griswold Industries, Vienna (AT)

(21) Appl. No.: 17/517,546

(22) Filed: Nov. 2, 2021

Related U.S. Application Data
(60) Provisional application No. 63/123,828, filed on Dec. 10, 2020.

(51) Int. Cl. G05D 16/20; F16K 31/365; F16K 31/04; F16K 31/126

(52) U.S. Cl. CPC G05D 16/202; F16K 31/365; F16K 31/1262; F16K 31/046; G05D 16/2095

(57) ABSTRACT

A control system for regulating fluid flow and pressure downstream a waterworks main valve includes a variable orifice device disposed upstream a pressure reducing pilot. The variable orifice device is in fluid communication with the pressure reducing pilot and a cover chamber of the main valve. Opening and closing the variable orifice device causes the main valve to modulate and the pressure of fluid downstream the main valve to be changed while avoiding pressure oscillations during the transition between pressure setpoints.

### RELATED APPLICATIONS

This application claims the benefit of U.S. Provisional Application No. 63/123,828, filed on Dec. 10, 2020, entitled PRESSURE REDUCING VALVE UTILIZING A VARIABLE ORIFICE FOR PRESSURE MODULATION CONTROL.

### FIELD OF THE INVENTION

The present invention generally relates to pressure reducing valves. More particularly, the present invention relates to a control system that utilizes a variable orifice for pressure modulation control in a waterworks system.

### BACKGROUND OF THE INVENTION

Pressure Reducing Valves (PRVs) are utilized in waterworks systems and many commercial fire protection systems throughout the world. PRVs are designed to automatically reduce a higher inlet pressure to a steady lower outlet pressure, regardless of changing flow rate and/or varying inlet pressure.

All known pressure reducing type valve products used in the waterworks industry utilize an adjustable pressure regulating pilot control in concert with a fixed orifice. Flow through the fixed orifice is directed to both the main valve cover and the inlet of the pressure regulating pilot. The regulating pilot modulates the flow from the fixed orifice to allow it to travel into or out of the main valve cover chamber, causing the main valve to modulate between open and closed positions. When the flow rate or volume of fluid through the regulating pilot control is less than the flow rate through the fixed orifice, this causes flow to be directed into the main valve cover chamber which causes the main valve to modulate towards the closed position. Conversely, when the flow rate through the regulating pilot control is greater than the flow rate through the fixed orifice, this causes the flow to be directed out of the main valve cover chamber and through the regulating pilot control, which causes the main valve to modulate towards the open position. Flow rates through the regulating pilot control and fixed orifice are a function of the flow areas and pressure differential values through these restrictions.

FIG. 1 shows a conventional arrangement wherein a main valve 100 has an inlet 118 and an outlet 104. A seat 106 is disposed intermediate the inlet 118 and outlet 104 and allows fluid to flow therethrough when the main valve 100 is at least partially open such as when main valve member 108 is not completely engaged with the seat 106. Main valve member 108 is attached to a diaphragm 110 which with a cover 112 of the main valve defines a cover chamber 114. Typically, the main valve member 108 is biased into the open position, although sufficient fluid pressure within the cover chamber 114 can overcome this bias and close the main valve member 108 until it comes into contact with the seat 106 to close the main valve 100 and prevent fluid flow from passing therethrough. The amount of fluid flow through the main valve 100 varies between this closed position and the open-most position wherein the main valve member 108 is biased to its open position.

FIG. 1 shows a conventional PRV with a pressure reducing pilot 116 where downstream pressure is determined by the adjusted set point of the pressure reducing pilot 116. A fixed orifice 118 is positioned where flow through the fixed orifice 118 can travel either into the main valve cover chamber 114 or through the pressure reducing pilot 116. The flow area through the seat (orifice) of the pressure reducing pilot 116 modulates such that this flow area can be less than, equal to or greater than the flow area through the fixed orifice 118 where these flow areas in combination with the pressure drop across these flow areas determine the flow rates through the pilot plumbing.

When the flow rate through the seat of the pressure reducing pilot 116 is less than the flow rate of the fixed orifice 118, part of the flow through the fixed orifice 118 is directed into the main valve cover chamber 114 causing the main valve to modulate towards the closed position. This activity causes pressure on the outlet of the main valve 100 to drop.

When the flow rate through the seat of the pressure reducing pilot 116 is greater than the flow rate of the fixed orifice 118, flow through the fixed orifice 118 and flow from the main valve cover chamber 114 exit through the pressure reducing pilot 116 causing the main valve 100 to modulate towards the open position. This modulation activity causes pressure on the outlet of the main valve 104 to stabilize at the set point of the pressure reducing pilot 116. This baseline pressure (or maximum prescribed pressure) set point value is based on the dynamics of the relationship between the fixed orifice 118 and the pressure reducing pilot 116. The outlet pressure of the main valve will remain at the set point value for all system flow rates as long as the flow rate relationship between the fixed orifice 118 and the pressure reducing pilot 116 remains unchanged.

When the flow rate through the seat of the pressure reducing pilot 116 is equal to the flow rate of the fixed orifice 118, flow through the fixed orifice 118 exits through the pressure reducing pilot 116 and there is no flow into or out of the main valve cover chamber causing the main valve 100 position to remain unchanged. This activity causes pressure on the outlet of the main valve 100 to remain unchanged or at the set point of the motor operated pressure reducing pilot 116.

If flow through the main valve 100 remains unchanged then pressure at the main valve 100 outlet 104 will remain unchanged or in equilibrium. However, if flow demand through the main valve 100 increases or decreases then a change in outlet pressure occurs which causes the pressure reducing pilot 116 to modulate. The pressure reducing pilot 116 will modulate accordingly so that outlet pressure tends towards the set point of the pressure reducing pilot 116. For applications where multiple downstream pressures are desired, the change in downstream pressure is achieved by changing the set point of the pressure reducing pilot 116. For pressure modulating valves with pilot plumbing, as shown in FIG. 1, flow into and out of the main valve cover chamber 114 is determined by the relationship of flow rates through the fixed orifice 118 and the seat of the pressure reducing pilot 116.

Flow into and out of the main valve cover chamber is determined by flow through these restrictions and in part by the spring force of the regulating pilot control 116. The spring force causes the flow rate through the regulating pilot control 116 to modulate allowing the flow through the regulating pilot control 116 to be greater than or less than the flow through the fixed orifice 118. This hydraulic arrangement of the pilot plumbing allows the pressure regulating pilot 116 to control flow into or out of the main valve cover 114 so that downstream pressure is maintained at the set point of the pressure regulating pilot 116.

The flow area ratio between the fixed orifice 118 and the seat of the pressure reducing pilot 116 is dependent on the pressure differentials existing between the inlet of the main valve and its cover chamber [ΔP_{1-CH}], and respectively between the cover chamber and the outlet pressure of the main valve [ΔP_{CH-2}], which can be practically identical. Therefore, if this flow area relationship between the fixed orifice 118 and pressure reducing pilot 116 changes then the baseline set point will be affected. For typical PRVs currently used in the marketplace, their modulation operation is dependent on the relationship between [ΔP_{1-CH}] and [Δ_{CH-2}]. Particularly the main valve construction may present at its regulating equilibrium position a practically equal pressure differentials [ΔP_{1-CH}] and [ΔP_{CH-2}], providing an accurate outlet pressure control by the pressure reducing pilot 116 regardless of the main valve rate of flow fluctuation.

When [ΔP_{1-CH}] is greater than [ΔP_{CH-2}] then this causes the main valve position to move towards the closed position which in turn lowers the outlet pressure until it approaches the set point of the pressure reducing pilot 116. As the outlet or downstream pressure approaches the set point this increases the pressure differential value of [ΔP_{CH-2}] until it is equal with [ΔP_{1-CH}]. When [ΔP_{1-CH}] and [ΔP_{CH-2}] become equal then the main valve position is in equilibrium again and the outlet pressure is equal to the set point of pressure reducing pilot 116. Conversely, when [ΔP_{1-CH}] is less than [ΔP_{CH-2}] then this causes the main valve position to move towards the open position which in turn raises the outlet pressure until it approaches the set point of the pressure reducing pilot 116. As the outlet pressure approaches the set point this decreases the pressure differential value of [ΔP_{CH-2}] until it is equal with [ΔP_{1-CH}]. When [ΔP_{1-CH}] and [ΔP_{CH-2}] become equal then the main valve position is in equilibrium again and the outlet pressure is equal to the set point of pressure reducing pilot 116.

This outlet pressure regulation dynamic is continuous as flow rate values through the main valve fluctuate. A drop in flow rate tends to raise the outlet pressure causing the main valve to move towards the closed position and an increase in flow rate tends to lower the outlet pressure causing the main valve to move towards the open position. The main valve modulates in this manner to maintain the regulation set point of pressure reducing pilot 116 where the main valve is in equilibrium when [ΔP_{1-CH}] and [ΔP_{CH-2}] are equal.

There are numerous PRVs configured as modulating pressure management type valves in the market that have a valve with a pilot plumbing arrangement that can change the system pressure conditions based on changes in demand. Some of these products accomplish this task hydraulically with controls that shift the pressure conditions when the demand changes. Typically valves of this type will have a hydraulic means to change the downstream pressure between two set points, a high demand high pressure set point and a low demand low pressure set point.

There are also numerous PRVs with motor operated regulators that are used in applications where there is a desire to change or modulate the system pressure set point when system demand conditions change. These systems utilize a pressure reducing (or pressure regulating) pilot for the main valve that modulates by allowing fluid pressure in the main valve cover to pass from the main valve cover through the seat or opening of the pressure reducing device. Downstream pressure is controlled by modulating the flow from the main valve cover through these regulators. Modulating PRVs of this type are all plumbed such that the regulators are positioned at the valve outlet. Outlet pressure is changed by changing the set point of the regulator.

These pressure regulating pilots utilize a spring force to adjust the opening area through the seat (or orifice) of the pressure reducing pilot so that it modulates to maintain the desired set pressure value. This modulating activity is used to regulate pressure in the main valve cover so that the main valve modulates to maintain the downstream pressure at the control set point for all flow demand conditions. In order to change the downstream pressure in the system, the spring force of the pressure reducing pilot is adjusted. The spring force is either adjusted manually or by means or a motor operated control. Typically, the motor operated pressure adjustment option is used in combination with a process controller, a pressure transducer and a flow meter where a process controller algorithm is used with the motor operated pressure reducing pilot to adjust the system pressure to the desired value such as a higher daytime pressures and lower nighttime pressures. Motor operated pressure regulators typically use spring forces that require a robust high wattage motor for spring adjustment. Because pressure reducing pilots of this nature typically need springs capable of exerting high spring forces, the motor operator likewise needs to be sufficiently powerful to handle the heavy spring loads and friction forces when making adjustments to the pressure set point. The higher power consumption requirements of these motors may not be readily available or sufficient battery power may be limited in some installations. Moreover, the battery life may not be sufficient to operate the motor control for extended periods.

Another challenge for pressure reducing valves (PRVs) with motor operated pressure regulating pilots is being able to smoothly transition between pressure set points when an adjustment change is made to the set point in an active waterworks system. Although transitions between set points can usually be programmed without experiencing pressure transition issues, occasionally pressure set point changes can create pressure oscillations in the water system network which can in turn cause the main valve to oscillate. This condition can sometimes be difficult to correct. In these pressure oscillation instances the pressure regulating pilot is responding to the pressure oscillations by increasing and decreasing its flow area (seat area). As the system pressure oscillates a pressure regulating pilot can over-compensate to these pressure swings and by doing so is unable to establish a steady state pressure in the system.

Accordingly, there is a continuing need for a pressure reducing valve in the form of a pressure control system for regulating fluid flow and pressure downstream a waterworks main valve which does not require a robust high wattage motor for spring adjustment of the pressure reducing pilot or regulator to adjust the system pressure to a desired value. What is also needed is a pressure reducing control system which does not overrespond or overcompensate to the pressure swings of the system, and is able to establish a steady state pressure in the system. The present invention fulfills these needs, and provides other related advantages.

### SUMMARY OF THE INVENTION

The present invention resides in a control system for regulating fluid flow and pressure downstream a waterworks main valve. The system of the present invention generally comprises a pressure reducing pilot having an inlet thereof in fluid communication with a cover chamber of the main valve and an outlet thereof in fluid communication with fluid downstream the main valve. The pressure reducing pilot has a preselected set point establishing a maximum downstream pressure. A variable orifice device is disposed upstream the pressure reducing pilot and has an inlet in fluid communication with fluid upstream the main valve and an outlet thereof in fluid communication with the inlet of the pressure reducing pilot and the cover chamber of the main valve.

Opening the variable orifice device adjusts the pressure of fluid downstream the main valve below the maximum downstream pressure. More particularly, increasingly opening a variable orifice of the variable orifice device increases flow to the pressure reducing pilot and/or the cover chamber of the main valve, causing the main valve to close and the downstream pressure to be reduced.

The variable orifice device may have a variable orifice defined at least in part by a movable stem disposed between an inlet and an outlet of the variable orifice device. The stem may be tapered.

The variable orifice device may be motor-operated. An electronic controller controls the motor of the variable orifice device to selectively open and close the variable orifice device.

A fixed orifice may also be disposed upstream of the pressure reducing pilot. An inlet of the fixed orifice is in fluid communication with the fluid upstream the main valve. An outlet of the fixed orifice is in fluid communication with the inlet of the pressure reducing pilot and the cover chamber of the main valve. The outlets of the variable orifice device and the fixed orifice may be in fluid communication with each other.

The invention may also be directed to a method for retrofitting a pressure control system of a waterworks main valve. A pressure control system comprising a pressure reducing pilot having an outlet in fluid communication with fluid downstream the main valve and an inlet in fluid communication with the cover chamber of the main valve is provided. A fixed orifice is disposed upstream the pressure reducing valve having an inlet in fluid communication with the fluid upstream the main valve and an outlet in fluid communication with the main valve cover chamber and the inlet of the pressure reducing pilot. The pressure reducing pilot has a preselected set point establishing a maximum downstream pressure.

A motor-operated variable orifice device is installed upstream of the pressure reducing valve. An inlet of the variable orifice device is in fluid communication with fluid upstream the main valve and an outlet in fluid communication with the inlet of the pressure reducing valve and the main valve cover chamber. Increasingly opening the variable orifice increases flow to the cover chamber of the main valve, causing the main valve to close and the downstream pressure to be reduced. The variable orifice device may be installed in parallel with the fixed orifice. An electronic controller may be used to control the motor of the variable orifice device to selectively open and close the variable orifice device, such as moving a movable stem disposed between the inlet and outlet of the variable orifice device which at least partially defines a variable orifice.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a cross-sectional and diagrammatic view of a prior art plumbing arrangement for waterworks pressure modulation control;

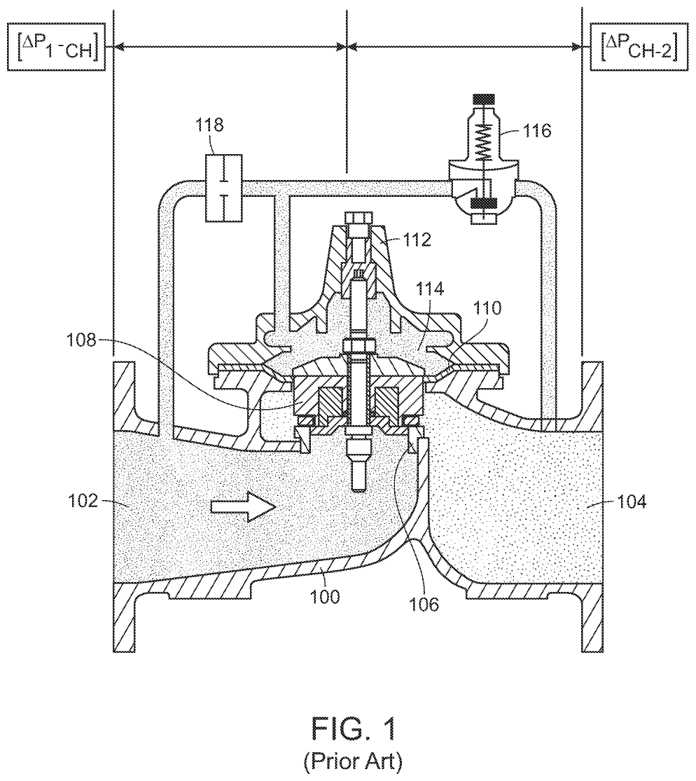

FIG. 2 is a perspective view of a pressure modulation control system incorporating a variable orifice device, in accordance with the present invention;

FIG. 3 is a partially sectioned view of the system of FIG. 2;

FIG. 4 is a cross-sectional view of a variable orifice device used in accordance with the present invention;

FIG. 5 is an enlarged cross-sectional view of area “5” of FIG. 4;

FIG. 6 is a schematic diagram illustrating a fluid flow and pressure modulation control system embodying the present invention;

FIG. 7 is a schematic diagram illustrating a fluid flow and pressure modulation control system embodying the present invention; and

FIG. 8 is a schematic diagram illustrating a fluid flow and pressure modulation control system embodying the present invention.

### DETAILED DESCRIPTION OF THE PREFERRED EMBODIMENTS

The present invention, as shown in the accompanying drawings for purposes of illustration, resides in a pressure reducing valve control system utilizing a variable orifice for pressure modulation control. The invention addresses a market demand for a low-power modulating pressure regulating type valve or a control system, such as having an application for a pressure management type valve or control system that can monitor the downstream pressure conditions and adjust or monitor those pressure conditions based on fluid demand situations throughout the system. An example would be in a water distribution or waterworks system where demand is high during the day and drops off at night. During nighttime or low-demand situations, it may be desirable to lower the water pressure to reduce water loss in the system, such as due to leaks throughout the system which may be attributed to old piping or poor seals at piping junctions or the like. By lowering the water pressure during low demand conditions, less water is lost through pipe leaks, etc.

Moreover, utilizing a variable orifice device minimizes the potential for causing pressure oscillations during the transition between pressure set points. In the system of the present invention, the pressure regulating or reducing pilot is not used to transition between pressure set points, but rather behaves more like a fixed orifice and working in this manner is less likely to overrespond or overcompensate when transitioning between pressure set points. The system of the present invention is configured so that the variable orifice is used to change the downstream pressure set point from the baseline or maximum pressure set point of the regulating pilot control.

More particularly, the system incorporates a motor operated variable orifice device 200 in combination with a fixed orifice 118 and a pressure reducing pilot 116 to change the downstream pressure set point from the baseline set point of the pressure reducing or regulating pilot, reducing or preventing pressure oscillations and overresponse when transitioning between pressure set points. By using a motor operated variable orifice device, less power is required to adjust the variable orifice opening as the variable orifice does not need to overcome the heavy spring forces of a conventional motor operated pressure regulator, so a low-powered motor can be utilized.

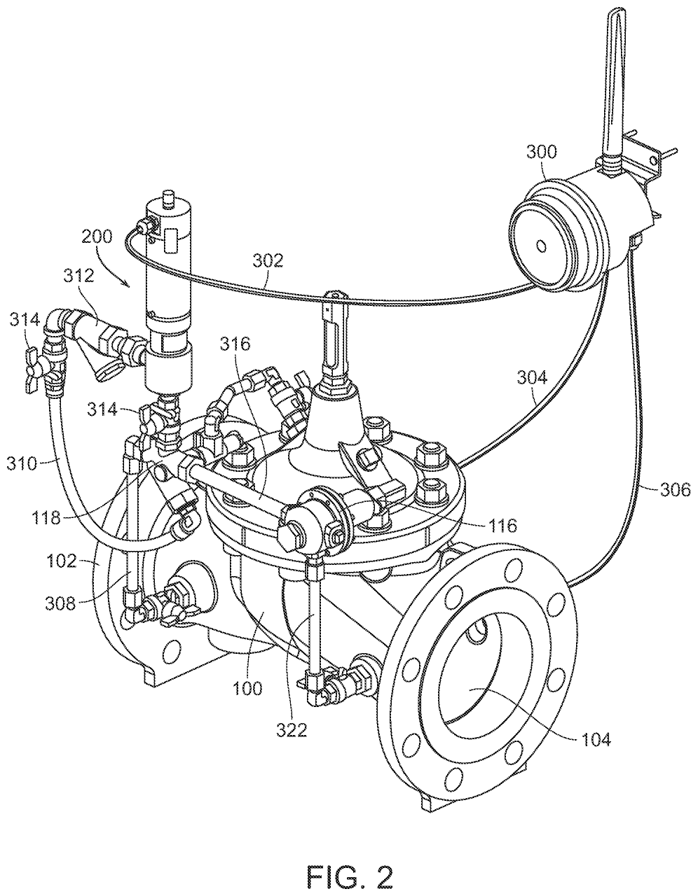

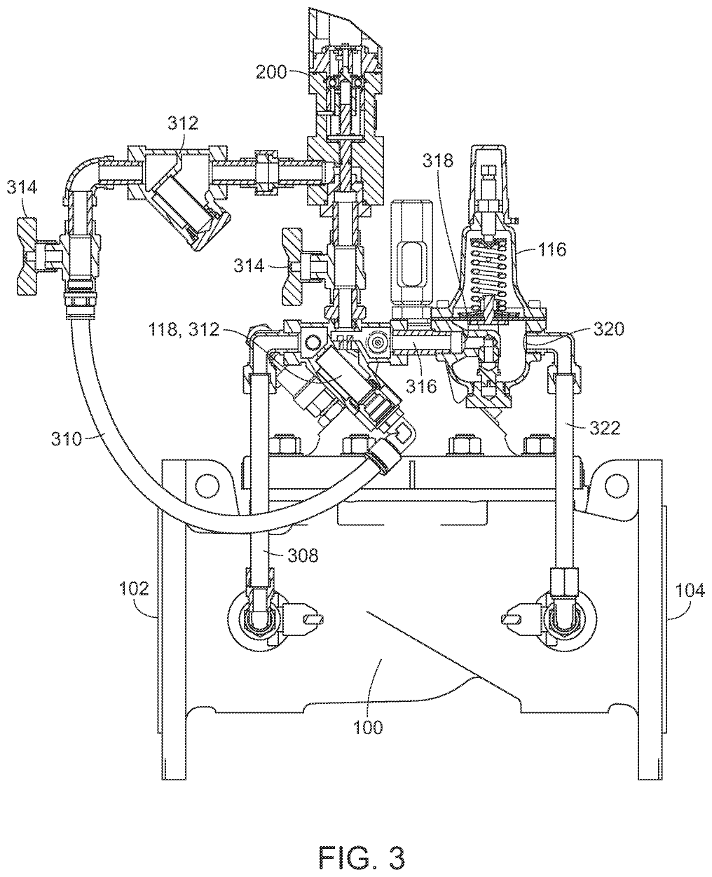

With reference now to FIGS. 2 and 3, the system of the present invention incorporates a variable orifice device 200, which is typically motor operated, upstream of the pressure reducing or regulating control 116. As used herein, “upstream” refers to fluid that has not passed through the seat 106 and “downstream” refers to fluid which has passed through the seat 106 of the main valve 100. Thus, the variable orifice device 200 is in fluid communication with fluid upstream of the main valve, which can include fluid which is in the main valve but which has not yet passed through the seat 106 of the main valve 100 and could also include fluid which is upstream of the main valve 100, although typically it will be understood that the fluid is diverted to the variable orifice device 200 which has entered into the inlet 102 of the main valve 100 but not yet passed through the seat 106 thereof. By contrast, the pressure reducing control 116 is disposed downstream of the variable orifice device 200 and is in fluid communication with fluid that has passed through the seat 106 of the main valve 100. Typically, this fluid is still within the main valve 100 before it leaves the outlet 104 thereof, but it will be understood that the fluid could be downstream from the main valve 100 as well.

Typically, the variable orifice device 200 is plumbed to the fixed orifice 118, such as in parallel with the fixed orifice 118, such that the fluid outlet of the fixed orifice 118 and the fluid outlet of the variable orifice device 200 both direct fluid to an inlet of the pressure reducing control 116 and/or the cover chamber 114 of the main valve 100. This is particularly the case when an existing pressure control system having a pressure reducing control 116 and a fixed orifice 118 is already in place and a variable orifice device 200 is incorporated into the existing system as a retrofit in order to accomplish the present invention.

However, it will be understood that the use of the variable orifice device 200 can eliminate the need for the fixed orifice 118 as all of the fluid can be directed through the variable orifice device 200 and the variable orifice of the variable orifice device be opened or closed so as to control the amount of fluid which is directed to the cover chamber 114 and/or inlet of the pressure reducing control pilot 116. In this case, the variable orifice device 200 would always be open at least to a minimum extent corresponding to what would be the equivalent of a fixed orifice. The variable orifice could then be opened, in accordance with the invention, to introduce additional fluid into the cover chamber 114 or to the pressure reducing control pilot 116 to increase fluid into the cover chamber 114, resulting in closure of the main valve 100 and a reduction of fluid flow through the main valve 100 and thus decreasing the downstream pressure, in accordance with the invention.

Pressure management is achieved by communication between a process controller 300 and the motor operated variable orifice control device 200, such as via an electrical lead 302 which extends between the process controller 300 and a motor of the variable orifice device 200 which opens and closes a variable orifice of the variable orifice device 200. Leads 304 and 306 may also extend between the process controller 300 and a flow meter and a pressure transducer, where a process controller algorithm is used with the motor operated variable orifice device 200 to adjust system pressure to the desired set point value, such as a higher set point for daytime pressures and a lower set point for nighttime pressures. As there are no heavy spring forces or adjustment screw thread friction forces typical of a motor operated pressure regulator or control device, the operating power of the motor used with the variable orifice device 200 is significantly lower than the power required for traditional motor operated pressure regulator control devices.

With continuing reference to FIGS. 2 and 3, in a typical embodiment upstream fluid is conveyed through a fluid conduit 308 to the fixed orifice 118. The fluid may pass through a strainer or a filter 312, which may be integrally formed with the fixed orifice 118. In the embodiment illustrated in FIGS. 2 and 3, a fluid conduit 310 extends between the strainer and/or fixed orifice 118 to an inlet of the variable orifice device 200. The fluid may pass through a strainer or filter 312. Moreover, a shut-off valve 314 may be incorporated to override the activity of the motor operated variable orifice pilot device 200 and return the downstream pressure set point to the maximum set point value initially established by the pressure reducing pilot 116. However, in normal operation mode of the present invention, the shut-off valve 314 remains open. Additional shut-off valves 314 may be incorporated into the system as needed or desired, such as between the outlet of the variable orifice device 200 and the fluid conduits passing to the main valve cover chamber 114 and/or the pressure reducing control pilot 116.

There may also a fluid conduit 316 extending between the outlet of the fixed orifice 118 and outlet of the variable orifice device 200 and the control chamber 114 of the main valve to the inlet 318 of the pressure reducing pilot control 116. As mentioned above, an outlet 320 of the pressure reducing control pilot 116 is in fluid communication with fluid downstream of the main valve 100, such as by means of fluid conduit 322.

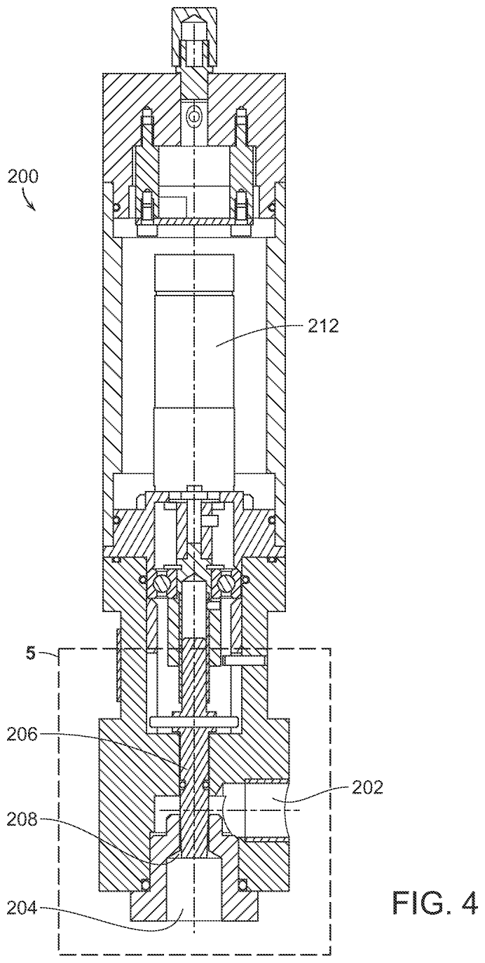

With reference now to FIG. 4, a cross-sectional view of an exemplary variable orifice device 200 is shown. The variable orifice device 200 includes a fluid inlet 202 which is in fluid communication with fluid upstream the main valve. The variable orifice device 200 also includes a fluid outlet 204 which as mentioned above is in fluid communication with the inlet of the pressure reducing pilot 116 and the cover chamber 114 of the main valve. A movable stem 206 is disposed between the inlet 202 and outlet 204 of the variable orifice device 200 to define a variable orifice 210 disposed in the passageway between the inlet 202 and the outlet 204. A small motor 212 of the variable orifice device 200 is used to raise and lower, or otherwise move, the stem 206 to open and close the passageway comprising the variable orifice between the inlet 202 and outlet 204.

The variable orifice feature of the motor operated variable orifice pilot 200 can be designed so the flow area change through the variable orifice opening 210 is as sensitive as desired. One method of controlling the sensitivity of the flow area through the variable orifice 210 is with tapering the stem 206. The tapered stem portion 208 is used to increase or decrease the flow area through the orifice by travelling axially through a fixed orifice opening. Customizing the taper of the stem feature allows the change in variable opening to be optimized for sensitivity. This sensitivity optimization can be important when making a change to the downstream pressure set point of the main valve 100. By maximizing the sensitivity of the variable orifice 210, changes in downstream pressure set point can be more precisely controlled which makes it less likely to cause pressure oscillations in the downstream piping when transitioning between set points.

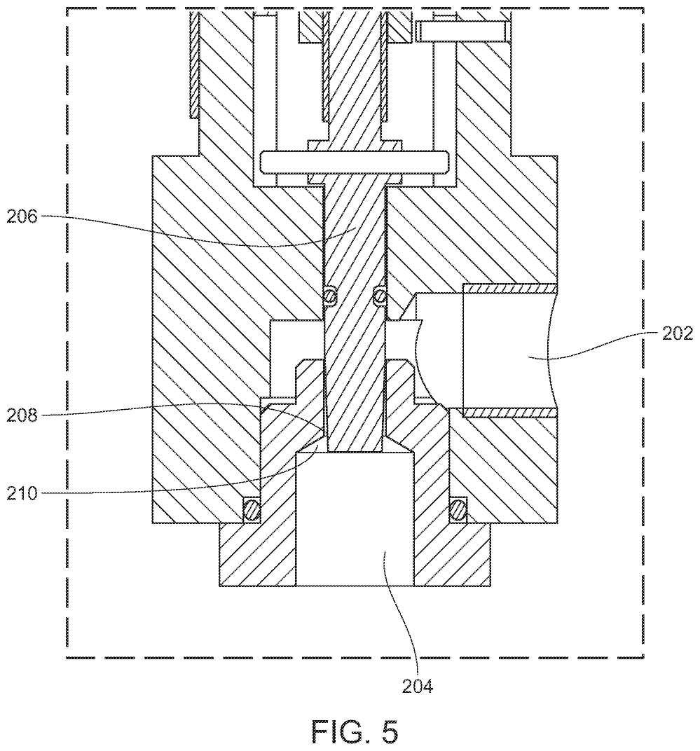

With continuing reference to FIGS. 4 and 5, the variable orifice device 200 uses a tapered stem 206 to vary the flow area through the orifice 210. When fully extended, as shown, the flow through the orifice 210 is fully restricted and pressure regulation is under command of the pressure regulating pilot 116. When the stem 206 travels upwardly, flow area through the orifice 210 increases and the pressure regulation set point is now under the command of the motor operated variable orifice device 200.

Adding a motor operated variable orifice pilot device 200, in accordance with the present invention, is a way to change the regulation relationship of the fixed orifice 118 and pressure reducing or regulating pilot 116. By adding a motor operated variable orifice pilot device 200 to the pilot plumbing, such as in a parallel arrangement with the fixed orifice 118 this adds to or permits an increase to the flowing area of the fixed orifice 118. By adding a motor operated variable orifice pilot 200, the ratio of flow areas between the fixed orifice 118 and pressure reducing pilot 116 can be changed. By means of the motor operated variable orifice pilot 200 the flow area can be incrementally increased which modifies the area ratio value.

This change in flow area relationship in the pilot plumbing changes the dynamics of the relationship between a fixed orifice 118 and the pressure reducing pilot 116. The pressure reducing pilot 116 can only partially compensate for the increase in flow from the motor operated variable orifice pilot device 200 and therefore the excess flow is directed into the main valve (Item 1) cover chamber causing the main valve 100 to modulate towards the closed position. This activity causes the downstream pressure to drop which establishes a new lower downstream pressure set point.

At this point the decrease of the outlet pressure forces the spring decompression of the pressure reducing pilot 116 accordingly, until the combined flow area relationship between the fixed orifice 118 associated variable orifice 210 and the pressure reducing pilot 116 is recovered. Or as previously explained, [ΔP_{1-CH}] and [ΔP_{CH-2}] are equal. Except now [ΔP_{1-CH}] is defined as the pressure differential value between the main valve cover chamber 114 and the combination of the fixed orifice 116 and variable orifice 210. The downstream pressure is still under control of the pressure reducing pilot 116, but at a lower set point generated by the motor operated variable orifice pilot device 200. At this point the downstream pressure set point is no longer under command of the pressure reducing pilot 116. The downstream pressure set point is now determined by the motor operated variable orifice pilot device 200.

Increasing the opening of the variable orifice 210 continues to lower the downstream pressure set point. If the variable orifice 210 is opened sufficiently the combined flow area of the fixed orifice 116 and motor operated variable orifice pilot device 200 can be greater than the flow area capacity of the pressure reducing pilot 116 which can cause the main valve 100 to close. This arrangement allows the downstream pressure set point to be adjusted from the baseline high pressure set point all the way down to a zero or near zero set point when the main valve closes. Therefore the lowest outlet pressure modulated value by the motor operated variable orifice pilot device 200 is reached when the combined flow area of the fixed orifice 116 and motor operated variable orifice pilot device 200 is practically equal to the flow area capacity of the pressure reducing pilot 116.

In addition to the unique pilot plumbing arrangement the motor operated variable orifice device 200 is used as the means to change the downstream pressure set point from a baseline value, as described above. The command to change the downstream pressure set point is typically determined from a process controller 300 where the downstream pressure values and flow values are monitored by means of a pressure transducer 324 and flow meter 326.

A variable orifice device 200 may be incorporated into an existing pressure regulating valve system to create the control system of the present invention or the control system of the present invention, incorporating the variable orifice device 200, may be plumbed and arranged in a variety of manners. In each case, however, the variable orifice device 200 will be in fluid communication with fluid upstream of the main valve 100 and plumbed or disposed upstream of the pressure reducing or regulating pilot 116 to accomplish the objectives of the invention. When a fixed orifice 118 is either already incorporated into the existing pressure reducing valve system or incorporated into the control system of the present invention, it also is in fluid communication with fluid upstream the main valve 100 and plumbed or disposed upstream of the pressure reducing pilot 116. Fluid from the outlets of the variable orifice device 200 and the fixed orifice 118 converge with each other or are otherwise directed to the inlet of the pressure reducing pilot 116 or the cover chamber 114 of the main valve 100 if the fluid flow exceeds the pressure reducing control pilot's throughput.

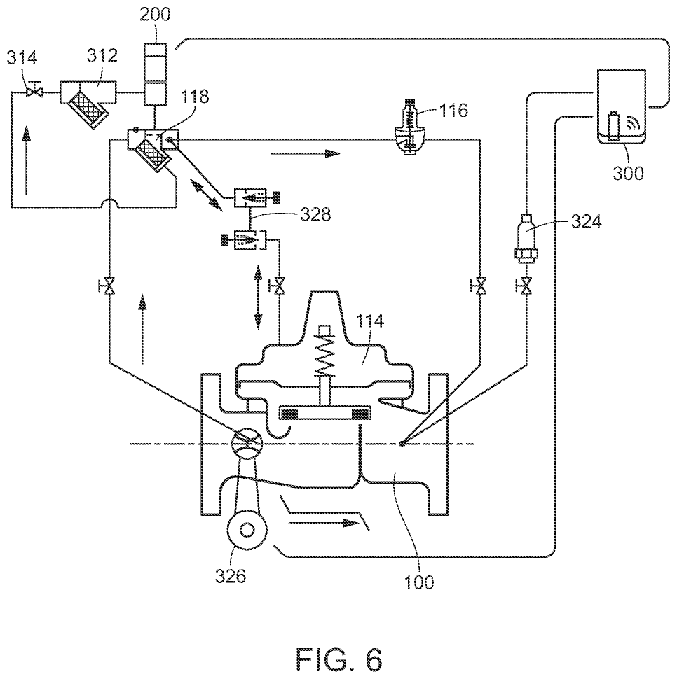

With reference to FIG. 6, an exemplary pilot plumbing arrangement for a control system with a motor operated variable orifice pilot device 200 for pressure modulation control and a manually operated pressure reducing control pilot 116 for a fixed or base line pressure control set point is shown. FIG. 6 shows a system with a motor operated variable orifice pilot device 200 where for multiple pressure set point applications the downstream pressure set point is determined by adjusting the opening of the motor operated variable orifice pilot device 200. For this system design, a variable orifice device 200 is used in combination with a fixed orifice 118 where flow through the variable orifice and fixed orifice, plumbed in parallel, can travel either into the main valve cover 114 or through a pressure reducing pilot 116.

In this arrangement a baseline pressure set point is established by closing the motor operated variable orifice pilot device 200 so that during this set point process all flow from the pilot plumbing enters through the fixed orifice 118. Typically the baseline maximum prescribed pressure set point is established at any flow rate through the main valve 100 being understood that it is corresponding to or representing the prescribed pressure at high flow (high demand) condition. The baseline pressure set point is the highest desired downstream pressure set point for the application. During this baseline pressure set point step the flow rate through the seat (orifice) of the pressure reducing pilot 116 modulates until it is balanced (or equal to) the flow rate through the fixed orifice 118. In this initial set point step, the downstream pressure is maintained at the set point value for all flow conditions. When the flow rate through the seat of the pressure reducing pilot 116 is less than the flow rate of the fixed orifice 118, part of the flow through the fixed orifice 118 is directed into the main valve cover chamber 114 causing the main valve 100 to modulate towards the closed position which in turn causes pressure on the outlet 104 of the main valve to drop.

The plumbing arrangement of the control system may include strainers 312, one-way flow controls 328 and other components as deemed necessary or desirable. The control system plumbing arrangement may also include one or more isolation valves (such as a ball valve) 314 used as a means to disable flow through the variable orifice device 200. When the isolation valve 314 is open downstream pressure set point values are under command of the variable orifice device 200 where an increase in flow area through the variable orifice tends to lower the downstream pressure set point and a decrease in flow area through the variable orifice tends to raise the downstream pressure set point. When the isolation valve 314 is closed downstream pressure values are under command of the pressure reducing pilot 116. Flow through the variable orifice device 200 is blocked. In this condition downstream pressure set point is fixed at the baseline pressure set point value of the pressure reducing pilot 116. Closing the isolation valve 314 can be used to either adjust the baseline pressure set point or as a means to override the motor operated variable orifice pilot device 200.

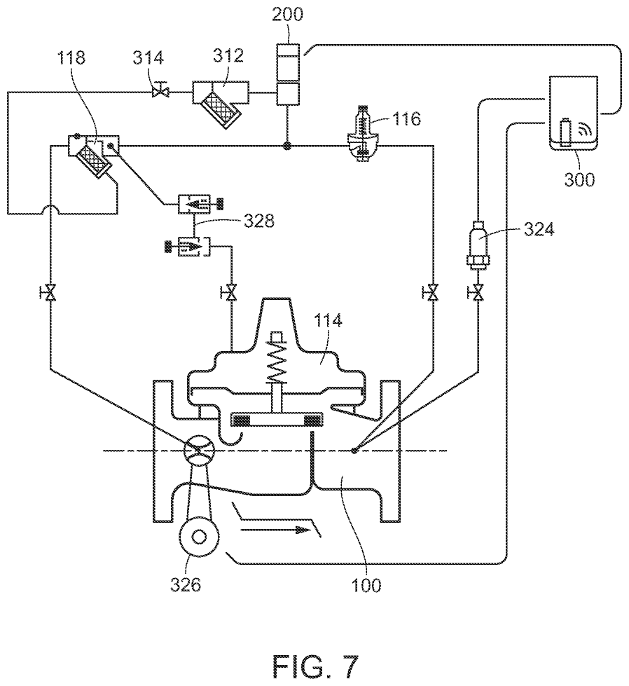

With reference to FIG. 7, another pilot plumbing arrangement for a pressure reducing valve control system with a motor operated variable orifice pilot device 200 for pressure modulation control and a manually operated pressure reducing control 116 or a fixed or baseline pressure control set point is shown. In this arrangement, the outlet of the motor operated variable orifice pilot device 200 is connected by a tee between the main valve cover chamber 114 and the inlet of the manually operated pressure reducing control 116.

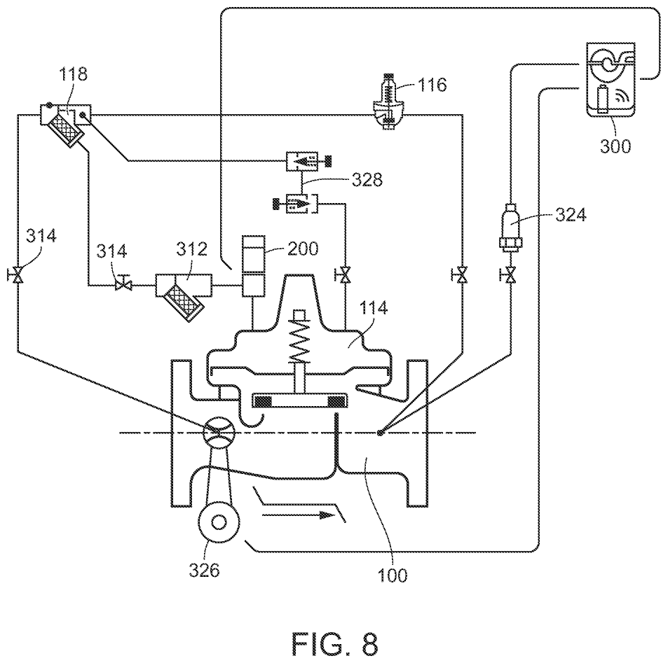

With reference now to FIG. 8, another pilot plumbing arrangement for a pressure reducing valve control system with a motor operated variable orifice pilot device 200 for pressure modulation control and a manually operated pressure reducing control 116 or a fixed or baseline pressure control set point is shown. In this arrangement, the outlet of the motor operated variable orifice pilot device 200 is connected to a boss on the main valve cover chamber 114. Fluid communication to the pressure reducing control 116 occurs through the piping connected to an opposing boss of the main valve cover chamber 114.

For control systems that use a pressure regulating pilot 116 in combination with a variable orifice device 200 and a fixed orifice 118, a change in downstream pressure set point is achieved by making an adjustment to the motor operated variable orifice control device 200. The pressure reducing control 116 is used to establish the baseline or highest pressure set point whereas the motor operated variable orifice control device 200 is used to establish pressure set points lower than the baseline. The position of the motor operated variable orifice control device 200 in the pilot plumbing of the control system is such that it is working in parallel with the fixed orifice 116. To work in a parallel flow path arrangement the motor operated variable orifice control device 200 can be plumbed in a variety of manners, as shown above.

In each of the control system arrangements, upstream fluid flow, such as flow from the valve inlet 102, enters the control system pilot plumbing and is directed through the fixed orifice 118 and the variable orifice device 200. Flow from these orifices is directed to the inlet of the pressure reducing control 116 or the cover chamber 114 of the main valve 100. The amount of flow into or out of the main valve cover chamber 114 is dependent on the flow area and pressure differential through the seat of the pressure reducing control 116. As explained above, the flow into the main valve cover chamber 114 occurs when the total flow rate (volume) through the fixed orifice 118 and variable orifice device 200 is greater than the flow rate through the seat of the pressure reducing control 116. This flow condition causes the main valve 100 to modulate towards the closed position which lowers the downstream pressure. Flow out of the main valve cover chamber 114 occurs when the total flow rate through the fixed orifice 118 and variable orifice device 200 is less than the flow rate through the seat of the pressure reducing control 116. This flow condition causes the main valve 100 to modulate towards the open position which raises the downstream pressure. A stable downstream pressure is obtained when the total flow rate (volume) through the combination of the fixed orifice 118 and variable orifice device 200 is equal to the flow area through the seat of the pressure reducing control 116. In all cases of flow rate change, the change transitions and downstream pressure are stable with no noticeable fluctuations or erratic behavior in downstream pressure values. The outlet pressure of the main valve is stable during the transition step even if there are minor flow oscillations occurring during the transition period.

Although several embodiments have been described in detail for purposes of illustration, various modifications may be made without departing from the scope and spirit of the invention. Accordingly, the invention is not to be limited, except as by the appended claims.

What is claimed is:

1. A control system for regulating fluid flow and pressure downstream a waterworks main valve, comprising:
a pressure reducing pilot having an inlet thereof in fluid communication with a cover chamber of the main valve and an outlet thereof in fluid communication with fluid downstream the main valve; and
a variable orifice device disposed upstream the pressure reducing pilot and having an inlet in fluid communication with fluid upstream the main valve and an outlet thereof in fluid communication with the inlet of the pressure reducing pilot and the cover chamber of the main valve;
wherein increasingly opening the variable orifice device increases flow to the pressure reducing pilot and/or the cover chamber of the main valve, causing the main valve to close and the downstream pressure to be reduced.

2. The control system of claim 1, wherein the pressure reducing pilot has a preselected set point establishing a maximum downstream pressure, and wherein opening the variable orifice device adjusts pressure of fluid downstream the main valve below the maximum downstream pressure.

3. The control system of claim 1, wherein the variable orifice device has a variable orifice defined at least in part by a movable stem disposed between an inlet and an outlet of the variable orifice device.

4. The control system of claim 3, wherein the stem is tapered.

5. The control system of claim 1, including a fixed orifice disposed upstream the pressure reducing pilot.

6. The control system of claim 5, wherein an inlet of the fixed orifice is in fluid communication with fluid upstream the main valve and an outlet of the fixed orifice is in fluid communication with the inlet of the pressure reducing pilot and the cover chamber of the main valve.

7. The control system of claim 6, wherein the outlets of the variable orifice device and the fixed orifice are in fluid communication with each other.

8. The control system of claim 1, wherein the variable orifice device is motor-operated.

9. The control system of claim 8, including an electronic controller that controls the motor of the variable orifice device to selectively open and close the variable orifice device.

10. A control system for regulating fluid flow and pressure downstream a waterworks main valve, comprising:
a pressure reducing pilot having an inlet thereof in fluid communication with a cover chamber of the main valve and an outlet thereof in fluid communication with fluid downstream the main valve, wherein the pressure reducing pilot has a preselected set point establishing a maximum downstream pressure;
a fixed orifice disposed upstream of the pressure reducing pilot and having an inlet in fluid communication with fluid upstream the main valve and an outlet thereof in fluid communication with the inlet of the pressure reducing pilot and the cover chamber of the main valve; and
a motor-operated variable orifice device disposed upstream the pressure reducing pilot and having an inlet in fluid upstream the main valve and an outlet thereof in fluid communication with the inlet of the pressure reducing pilot and the cover chamber of the main valve;
wherein increasingly opening the variable orifice increases flow to the cover chamber of the main valve, causing the main valve to close and the downstream pressure to be reduced.

11. The control system of claim 10, wherein the variable orifice device having a variable orifice defined at least in part by a movable stem disposed between an inlet and an outlet of the variable orifice device.

12. The control system of claim 11, wherein the variable orifice device stem is tapered.

13. The control system of claim 10, including an electronic controller that controls the motor of the variable orifice device to selectively open and close the variable orifice device.

14. A method for retrofitting a pressure control system of a waterworks main valve, comprising the steps of:
providing a pressure control system comprising a pressure reducing pilot having an outlet in fluid communication with fluid downstream the main valve and an inlet in fluid communication with a cover chamber of the main valve, and a fixed orifice disposed upstream the pressure reducing valve having an inlet in fluid communication with fluid upstream the main valve and an outlet in fluid communication with the main valve cover chamber and the inlet of the pressure reducing pilot, wherein the pressure reducing pilot has a preselected set point establishing a maximum downstream pressure; and
installing a motor-operated variable orifice device upstream of the pressure reducing valve, an inlet of the variable orifice device being in fluid communication with fluid upstream the main valve and an outlet thereof in fluid communication with the inlet of the pressure reducing valve and the main valve cover chamber, wherein increasingly opening the variable orifice increases flow to the cover chamber of the main valve, causing the main valve to close and the downstream pressure to be reduced.

15. The method of claim 14, including the step of installing the variable orifice device in parallel with the fixed orifice.

16. The method of claim 14, wherein the variable orifice device has a movable stem disposed between the inlet and outlet thereof and at least partially defining a variable orifice.

17. The method of claim 16, wherein the stem is tapered.

18. The method of claim 14, including the step of using an electronic controller to control the motor of the variable orifice device to selectively open and close the variable orifice device.
